(19) United States
(12) Patent Application Publication
(10) Pub. No.: US 2016/0039073 A1
(43) Pub. Date: Feb. 11, 2016

(54) Device for screwing and unscrewing bolts/nuts

(71) Applicant: Adrian Balota, Suffolk, VA (US)

(72) Inventor: Adrian Balota, Suffolk, VA (US)

(21) Appl. No.: 14/456,060

(22) Filed: Aug. 11, 2014

(51) Int. Cl. B25B 13/18; B25B 13/32

(52) U.S. Cl. CPC B25B 13/18; B25B 13/32

(57) ABSTRACT

Device for screwing and unscrewing bolts/nuts, comprising a lever, two jaws mounted between two side plates, with spacers guiding and holding the components together. The said lever rotates a certain angle around an axis moving the two jaws inward or outward. When move inward the jaws clutch the bolt head/nut and when move outward the bolt head/nut is released. The screwing or unscrewing is done without retracting the device out of the axis of the bolt/nut.

The device is much more suitable when used for threaded fittings along the pipes or cable connectors like those for coaxial TV cable.

The present invention relates to a hand device used for screwing and unscrewing screws bolts, nuts and the like.

The device as described below has a simple construction comprising a middle lever, two jaws mounted between two side plates, with spacers guiding and holding the components together. The said middle lever has two pins that move the said jaws in opposite direction when is rotated.

### PRIOR ART

To screw/unscrew bolts/nuts the technicians usually use many time open-end wrenches. The operation has frequent interruptions do to the impossibility to rotate the tool continuously process that takes long time. They have to change the position of the wrench every rotation. Usually the technician turn the wrench about a third of a full rotation (120°). To screw a part having as little as 10 threads the technician has to retract, change the position and replace the tool for as much as 30 times.

### PRESENT INVENTION

The object of the present invention is to provide a device to screw bolts/nuts without interruptions eliminating the need to reposition the wrench every turn and so reducing considerably the time necessary for this operation.

The same device can be used to screw/unscrew different fastener shapes: hexagonal, squared, octagonal, etc., and different fasteners size.

One of the novelties of the present invention consists in simplicity of its construction.

There are multiple ways to build such a device using a large variety of materials, shapes and techniques. The drawings associated with this description give a better understanding of the construction and functionality of the device.

### THE DESCRIPTION OF THE DRAWINGS

FIG. 1 is a general view of the device

FIG. 2 is an exploded view

FIG. 3 shows the maximum opening of the device

FIG. 4 shows the minimum opening of the device

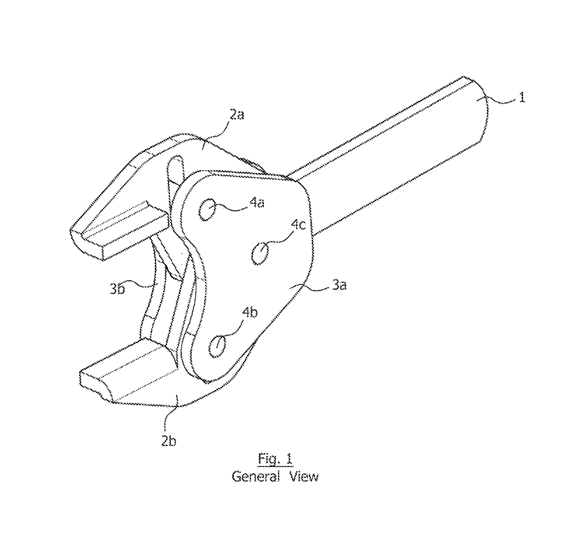

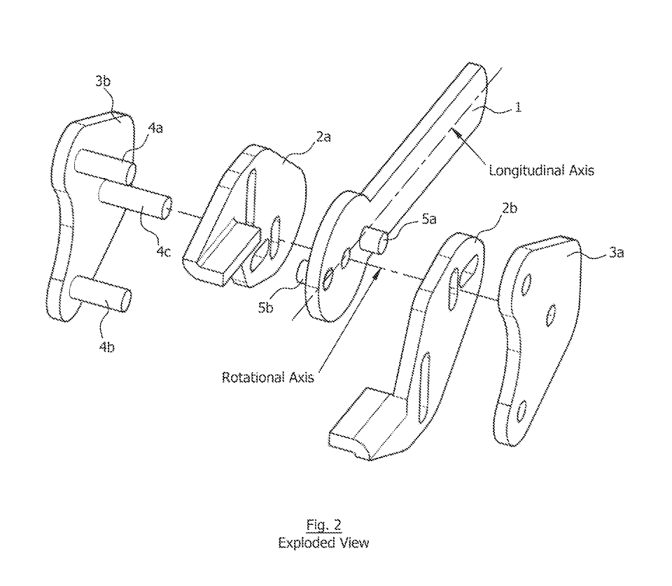

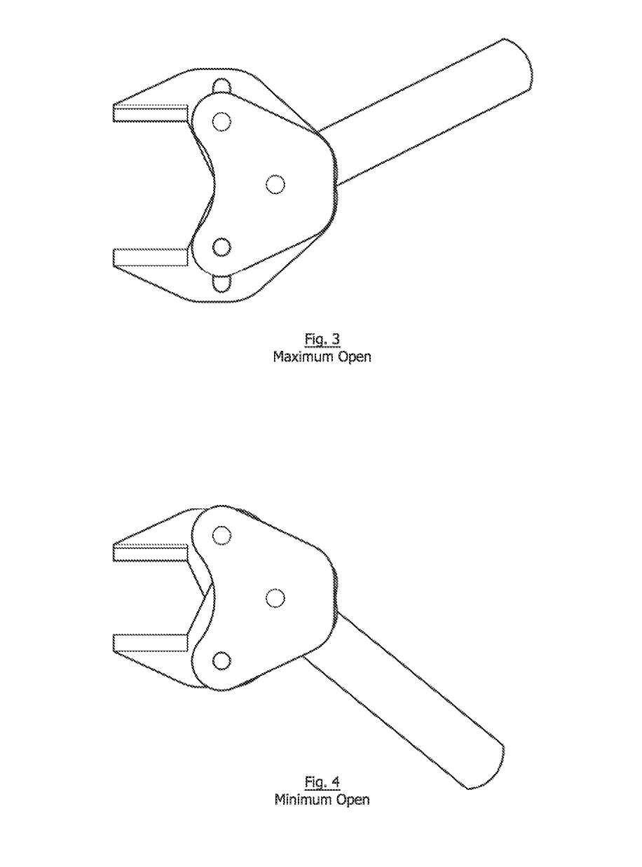

The device for screwing and unscrewing bolts/nuts conform with the exploded view on FIG. 2 consists of a middle lever (1), two jaws (2a, 2b) mounted between two side plates (3a, 3b), with spacers (4a, 4b and 4c) that guide and hold together the components.

The said middle lever (1) has a hole in the center of its round shape and two pins (5a, 5b) placed one each face, equally distanced to the center, perpendicular to the longitudinal axis of the part. The pins are solid connected to the middle lever (welded, pressed, etc.).

The two jaws 2a and 2b are placed on the right side and the left side of the middle lever respectively. They are the parts that will be in contact with the bolt/screw. Both jaws have two vertical and one horizontal obround (slotted) holes. The vertical obround holes serve as a guide for the movement of the jaws.

The said side plates (3a, 3b), placed on the left and right of the device hold together the whole components. In this example the three spacers (4a, 4b and 4c) are solid connected to both 3a and 3b sides (welded, pressed, etc.). All three spacers serve also as guide for the movement of the jaws.

The upper spacer (4a), connected to the right side plate (3b), goes through the vertical upper hole of the right jaw (2a) then connects to the left side plate (3a). The lower spacer (4b), connected to the right side plate (3b), goes through the vertical lower hole of the left jaw (2b) then connects to the left side plate (3a).The central spacer (4c) connected to the right side plate (3b), goes through the central vertical obround hole in right jaw (2a), through the central hole in the middle lever (1), through the central vertical obround hole in the left jaw (2b), then connects to the left side plate (3a). Spacer (4c) serves also as rotation axle for the middle lever. The pin 5a on the middle lever goes through the horizontal obround hole in the left jaw (2b) and the pin (5b) goes through the horizontal obround hole in the right jaw (2a). The length of the pins is not exceeding the thickness of the jaws.

The device acts like a ratchet wrench. By rotating the middle lever the pins move the two jaws inward or outward. To screw or unscrew a bolt/nut the operator place the device on the bolt head/nut and rotates the lever. The jaws moves inward, clutches the bolt head/nut. At this point the device is tight connected to the bolt head/nut and will rotate—within a certain angle—with the movement of the lever screwing it or unscrewing it. Then, without retracting the device out from the bolt/nut axis, the operator rotates the device in opposite direction, to disengage the jaws. The jaws move outward and the bolt/nut is released. Next the operator continue to rotate the lever to a convenient angle to redo the screwing/unscrewing sequence. The entire screwing/unscrewing process is done without retracting the device out from the bolt/nut axis. To screw or unscrew a part the device needs to be turned 180 degree along with its longitudinal axis.

The length of the obround holes in the jaws will determine how much the lever will move and how much the jaws will open and close.

### REFERENCES

U.S. Pat. No. 5,016,503 May 21, 1991—Carlyle d. Morton

U.S. Pat. No. 5,768,958 Jun. 23, 1998—Bruce H. Gamble

U.S. Pat. No. 6,151,996 Nov. 28, 2000—Carlton I. Whiteford

U.S. Pat. No. 6,810,773 Nov. 2, 2004—Frank Trucchio

U.S. Pat. No. 7,895,920 May 1, 2011—Hani A. Abunamech

1. Device for screwing or unscrewing bolts/nuts comprising a middle lever, two jaws placed each side of the said middle lever and mounted between two side plates with spacers holding the components together, one of the said spacers placed in the center of the device, the said jaws having flat gripping surface capable to engage a range of sizes of fastener elements, the said middle lever having a rotational axis defined by the central spacer.

2. A device according to the claim 1 where the said jaws move in opposite direction, inward and outward, simultaneously, when the said middle lever is rotated forwards and backwards around of its rotational axis.

3. A device according to the claim 1, where the said middle lever moves the said jaws by the means of two pins placed one each face of the said middle lever coincident to its longitudinal axis and equally distanced to the rotational axis.
